(19) United States
(12) Patent Application Publication
(10) Pub. No.: US 2025/0391399 A1
(43) Pub. Date: Dec. 25, 2025

(54) Aligning Speech and Text Representations without Sampling

(71) Applicant: Google LLC, Mountain View, CA (US)

(72) Inventors: Neeraj Gaur, Jersey City, NJ (US); Rohan Agrawal, Brooklyn, NY (US); Yuan Wang, Hoboken, NJ (US); Parisa Haghani, Atlanta, GA (US); Andrew Maxwell Rosenberg, Brooklyn, NY (US); Bhuvana Ramabhadran, Mt. Kisco, NY (US)

(73) Assignee: Google LLC, Mountain View, CA (US)

(21) Appl. No.: 19/241,129

(22) Filed: Jun. 17, 2025

Related U.S. Application Data
(60) Provisional application No. 63/663,459, filed on Jun. 24, 2024.

(51) Int. Cl. G10L 15/06; G10L 15/16

(52) U.S. Cl. CPC G10L 15/063; G10L 15/16; G10L 2015/0635

(57) ABSTRACT

A method includes receiving transcribed speech utterances, and for each respective transcribed speech utterance: generating, using a text encoder, a corresponding encoded textual representation of a corresponding transcription; generating a first probability distribution over possible speech recognition hypotheses for the corresponding encoded textual representation; generating, using a speech encoder, a corresponding encoded audio representation of the respective transcribed non-synthetic speech utterance; generating a second probability distribution over possible speech recognition hypotheses for the corresponding encoded audio representation, each possible speech recognition hypothesis of the second probability distribution comprising at least one blank output token; and determining a consistency loss based on the first and second probability distributions and the at least one non-blank output token of each possible speech recognition hypothesis of the second probability distribution. The method also includes pre-training the audio encoder based on the consistency losses.

### CROSS-REFERENCE TO RELATED APPLICATIONS

This U.S. patent application claims priority under 35 U.S.C. § 119 (e) to U.S. Provisional Application 63/663,459, filed on Jun. 24, 2024. The disclosure of this prior application is considered part of the disclosure of this application and is hereby incorporated by reference in its entirety.

### TECHNICAL FIELD

This disclosure relates to aligning speech and text representations without sampling.

### BACKGROUND

Automatic speech recognition (ASR), the process of taking an audio input and transcribing it into text, has greatly been an important technology that is used in mobile devices and other devices. In general, automatic speech recognition attempts to provide accurate transcriptions of what a person has said by taking an audio input (e.g., speech utterance) and transcribing the audio input into text. Modern ASR models continue to improve in both accuracy (e.g. a low word error rate (WER)) and latency (e.g., delay between the user speaking and the transcription) based on the ongoing development of deep neural networks. However, one challenge in developing deep learning-based ASR models is that parameters of the ASR models tend to over fit the training data, thereby resulting in the ASR models having difficulties generalizing unseen data when the training data is not extensive enough. As a result, training ASR models on larger training datasets improves the accuracy of the ASR model. Synthesized speech and/or data-augmented speech can be incorporated to increase the volume of training data used to train the ASR models.

### SUMMARY

One aspect of the disclosure provides a computer-implemented method that when executed on data processing hardware causes the data processing hardware to perform operations that include receiving training data for pre-training an audio encoder, the training data including transcribed non-synthetic speech utterances and each respective transcribed non-synthetic speech utterance is paired with a corresponding transcription. For each respective transcribed non-synthetic speech utterance, the operations also include: generating, using a text encoder of the audio encoder, a corresponding encoded textual representation of the corresponding transcription; generating a first probability distribution over possible speech recognition hypotheses for the corresponding encoded textual representation; generating, using a speech encoder of the audio encoder, a corresponding encoded audio representation of the respective transcribed non-synthetic speech utterance; generating a second probability distribution over possible speech recognition hypotheses for the corresponding encoded audio representation, each possible speech recognition hypothesis of the second probability distribution comprising at least one blank output token and at least one non-blank output token; and determining a consistency loss based on the first probability distribution over possible speech recognition hypotheses and the at least one non-blank output token of each possible speech recognition hypothesis of the second probability distribution. The operations also include pre-training the audio encoder based on the consistency loss determined for each respective transcribed non-synthetic speech utterance to teach the audio encoder to jointly learn shared speech and text representations.

Implementations of the disclosure may include one or more of the following optional features. In some implementations, the audio encoder includes a stack of self-attention layers each including a multi-headed self-attention mechanism. Additionally, the consistency loss may not based on the at least one blank output token of each possible speech recognition hypothesis of the second probability distribution. The consistency loss may include a weighted Recurrent Neural Network-Transducer (RNN-T) loss of the at least one non-blank output token of each possible speech recognition hypothesis of the second probability distribution.

In some examples, the training data further includes unspoken textual utterances and un-transcribed non-synthetic speech utterances, and the audio encoder is further pre-trained on the unspoken textual utterances and the un-transcribed non-synthetic speech utterances to jointly learn the shared speech and text representations. Each unspoken textual utterance is not paired with any corresponding spoken utterance of non-synthetic speech and each un-transcribed non-synthetic speech utterance is not paired with a corresponding transcription. In these examples, pre-training the audio encoder may include: generating a corresponding encoded representation of the un-transcribed non-synthetic speech utterance for each respective un-transcribed non-synthetic speech utterance, pre-training the audio encoder on a contrastive loss applied on the corresponding encoded representation for respective un-transcribed non-synthetic speech utterance; generating a corresponding encoded representation of the respective unspoken textual utterance for each respective unspoken textual utterance; pre-training the audio encoder on a contrastive loss applied on the corresponding encoded representation for each respective unspoken textual utterance; generating a corresponding encoded representation for each respective transcribed non-synthetic speech utterance; and pre-training the audio encoder on a contrastive loss applied on the corresponding encoded representation for each respective transcribed non-synthetic speech utterance.

Pretraining the audio encoder may also include, at each of a plurality of output steps for each respective unspoken textual utterance: generating, using an auxiliary decoder, a third probability distribution over possible speech recognition hypotheses for the respective unspoken textual utterance; determining an output loss term based on the third probability distribution over possible speech recognition hypotheses and the respective unspoken textual utterance; and pre-training the audio encoder based on the output loss term. Additionally, at each of a plurality of output steps for each transcribed non-synthetic speech utterance, pretraining the audio encoder further includes determining a non-synthetic speech loss term based on the second probability distribution over possible speech recognition hypotheses and the corresponding transcription paired with the respective transcribed non-synthetic speech utterance, and pre-training the audio encoder based on the non-synthetic speech loss term. The auxiliary decoder may include one of a Connection Temporal Classification (CTC) decoder, a Listen Attend Spell (LAS) decoder, or Recurrent Neural Network-Transducer (RNN-T) decoder.

In some implementations, the audio encoder includes a shared encoder. In these implementations, the operations may also include determining, using the text encoder, an encoded textual representation of each respective unspoken textual utterance, generating, using the shared encoder, a first encoded shared representation of each respective unspoken textual utterance in a shared latent representation space, and for each respective transcribed non-synthetic speech utterance, generating, using the shared encoder, a second encoded shared representation of the transcribed non-synthetic speech utterance in a shared latent representation space.

Another aspect of the disclosure provides a system that includes data processing hardware and memory hardware storing instructions that when executed on the data processing hardware causes the data processing hardware to perform operations that include receiving training data for pre-training an audio encoder, the training data including transcribed non-synthetic speech utterances and each respective transcribed non-synthetic speech utterance is paired with a corresponding transcription. For each respective transcribed non-synthetic speech utterance, the operations also include: generating, using a text encoder of the audio encoder, a corresponding encoded textual representation of the corresponding transcription; generating a first probability distribution over possible speech recognition hypotheses for the corresponding encoded textual representation; generating, using a speech encoder of the audio encoder, a corresponding encoded audio representation of the respective transcribed non-synthetic speech utterance; generating a second probability distribution over possible speech recognition hypotheses for the corresponding encoded audio representation, each possible speech recognition hypothesis of the second probability distribution comprising at least one blank output token and at least one non-blank output token; and determining a consistency loss based on the first probability distribution over possible speech recognition hypotheses and the at least one non-blank output token of each possible speech recognition hypothesis of the second probability distribution. The operations also include pre-training the audio encoder based on the consistency loss determined for each respective transcribed non-synthetic speech utterance to teach the audio encoder to jointly learn shared speech and text representations.

This aspect of the disclosure may include one or more of the following optional features. In some implementations, the audio encoder includes a stack of self-attention layers each including a multi-headed self-attention mechanism. Additionally, the consistency loss may not based on the at least one blank output token of each possible speech recognition hypothesis of the second probability distribution. The consistency loss may include a weighted Recurrent Neural Network-Transducer (RNN-T) loss of the at least one non-blank output token of each possible speech recognition hypothesis of the second probability distribution.

In some examples, the training data further includes unspoken textual utterances and un-transcribed non-synthetic speech utterances, and the audio encoder is further pre-trained on the unspoken textual utterances and the un-transcribed non-synthetic speech utterances to jointly learn the shared speech and text representations. Each unspoken textual utterance is not paired with any corresponding spoken utterance of non-synthetic speech and each un-transcribed non-synthetic speech utterance is not paired with a corresponding transcription. In these examples, pre-training the audio encoder may include: generating a corresponding encoded representation of the un-transcribed non-synthetic speech utterance for each respective un-transcribed non-synthetic speech utterance, pre-training the audio encoder on a contrastive loss applied on the corresponding encoded representation for respective un-transcribed non-synthetic speech utterance; generating a corresponding encoded representation of the respective unspoken textual utterance for each respective unspoken textual utterance; pre-training the audio encoder on a contrastive loss applied on the corresponding encoded representation for each respective unspoken textual utterance; generating a corresponding encoded representation for each respective transcribed non-synthetic speech utterance; and pre-training the audio encoder on a contrastive loss applied on the corresponding encoded representation for each respective transcribed non-synthetic speech utterance.

Pretraining the audio encoder may also include, at each of a plurality of output steps for each respective unspoken textual utterance: generating, using an auxiliary decoder, a third probability distribution over possible speech recognition hypotheses for the respective unspoken textual utterance; determining an output loss term based on the third probability distribution over possible speech recognition hypotheses and the respective unspoken textual utterance; and pre-training the audio encoder based on the output loss term. Additionally, at each of a plurality of output steps for each transcribed non-synthetic speech utterance, pretraining the audio encoder further includes determining a non-synthetic speech loss term based on the second probability distribution over possible speech recognition hypotheses and the corresponding transcription paired with the respective transcribed non-synthetic speech utterance, and pre-training the audio encoder based on the non-synthetic speech loss term. The auxiliary decoder may include one of a Connection Temporal Classification (CTC) decoder, a Listen Attend Spell (LAS) decoder, or Recurrent Neural Network-Transducer (RNN-T) decoder.

In some implementations, the audio encoder includes a shared encoder. In these implementations, the operations may also include determining, using the text encoder, an encoded textual representation of each respective unspoken textual utterance, generating, using the shared encoder, a first encoded shared representation of each respective unspoken textual utterance in a shared latent representation space, and for each respective transcribed non-synthetic speech utterance, generating, using the shared encoder, a second encoded shared representation of the transcribed non-synthetic speech utterance in a shared latent representation space.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIG. 2 is a schematic view of a Recurrent Neural Network-Transducer (RNN-T) model architecture.

FIGS. 3A-3C are schematic views of an example training process for pre-training an audio encoder of a speech recognition model.

FIG. 4 is a schematic view of an example unspoken text selection process for selecting unspoken textual utterances pertaining to a specific domain.

FIG. 5 is a schematic view of example projection space encoder representations of non-synthetic and synthetic speech.

FIG. 6 is a schematic view of an example alignment lattice.

FIG. 7 is a flowchart of an example arrangement of operations for a method of pre-training an audio encoder to jointly learn shared representations of speech and text.

FIG. 8 is a schematic view of an example computing device that may be used to implement the systems and methods described herein.

Like reference symbols in the various drawings indicate like elements.

### DETAILED DESCRIPTION

Automated speech recognition has made tremendous strides with the introduction of sequence to sequence (Seq2Seq) models that map from audio to character sequences. At the same time, text-to-speech (TTS) or speech syntheses systems have successfully applied Seq2Seq models to obtain state of the art natural, realistic sounding synthesized speech that can be indistinguishable to the human ear from human speech.

One challenge in developing deep learning-based ASR models is that parameters of the ASR models tend to over fit the training data, thereby resulting in the ASR models having difficulties generalizing unseen data when the training data is not extensive enough. Thus, training ASR models on larger training datasets improves the accuracy of the ASR model. For instance, the use of machine learning or other statistical methods can train ASR models on training data sets that include upwards of 10,000 hours of transcribed speech. Yet, performance of ASR models suffers when a domain associated with the training data is distinct from a domain at which the ASR model will be deployed during inference. For example, training an ASR model on transcribed speech in a domain associated with video meetings would be less effective in recognizing speech related to voice search queries, and vice versa.

Unpaired text data has the potential to drastically limit the amount of labeled human speech required to train ASR models, while also providing flexibility in moving the ASR model across different domains. Using text data (i.e., unpaired text data) in addition to speech data to train ASR models, however, presents a challenge with combining speech and text modalities of the training data. One current approach includes upsampling textual training data to match the length of corresponding audio training data. These approaches upsamples the textual training data using a fixed duration model or a trained duration model. Yet, even state-of-the-art duration models generate misalignments between the textual training data and the audio training data causing ASR models to train on misaligned training data.

Implementations herein are directed toward aligning a training process that pre-trains an audio encoder to jointly learn shared representations of speech and text without sampling. In particular, the training process includes receiving training data for pre-training an audio encoder of a speech recognition model. The training data includes transcribed non-synthetic speech utterances each paired with a corresponding transcription. For each respective transcribed non-synthetic speech utterance, the training process includes generating a corresponding encoded textual representation, generating a first probability distribution over possible speech recognition hypotheses for the corresponding encoded textual representation, generating a corresponding encoded audio representation, generating a second probability distribution over possible speech recognition hypotheses for the corresponding encoded audio representation, and determining a consistency loss based on the first probability distribution over possible speech recognition hypotheses and the second probability distribution over possible speech recognition hypotheses. Each possible speech recognition hypothesis of the second probability distribution includes at least one blank output token and at least one non-blank output token. As will become apparent, the training process determines the consistency loss based on the first probability distribution over possible speech recognition hypotheses and the at least one non-blank output token of each possible speech recognition hypothesis of the second probability distribution. The training process also includes pre-training the audio encoder on the consistency loss determined for each respective transcribed non-synthetic speech utterance to teach the audio encoder to jointly learn shared speech and text representations.

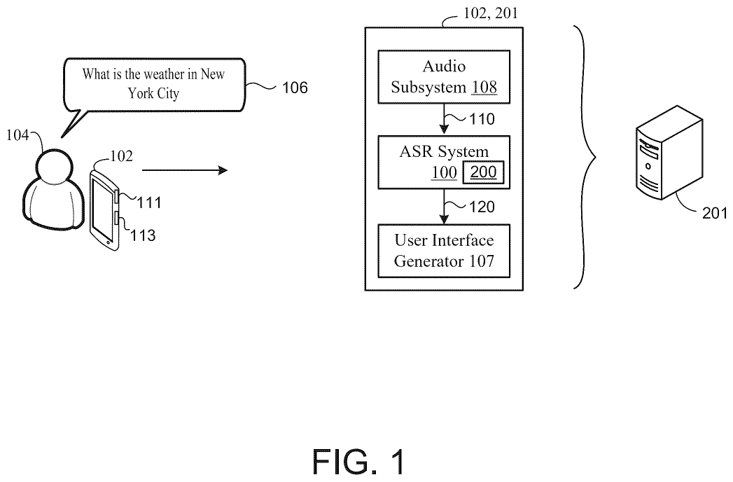

FIG. 1 illustrates an automated speech recognition (ASR) system 100 implementing an ASR model 200 that resides on a user device 102 of a user 104 and/or on a remote computing device 201 (e.g., one or more servers of a distributed system executing in a cloud-computing environment) in communication with the user device 102. Although the user device 102 is depicted as a mobile computing device (e.g., a smart phone), the user device 102 may correspond to any type of computing device such as, without limitation, a tablet device, a laptop/desktop computer, a wearable device, a digital assistant device, a smart speaker/display, a smart appliance, an automotive infotainment system, or an Internet-of-Things (IoT) device, and is equipped with data processing hardware 111 and memory hardware 113.

The user device 102 includes an audio subsystem 108 configured to receive an utterance 106 spoken by the user 104 (e.g., the user device 102 may include one or more microphones for recording the spoken utterance 106) and convert the utterance 106 into a corresponding digital format associated with input acoustic frames 110 capable of being processed by the ASR system 100. In the example shown, the user speaks a respective utterance 106 in a natural language of English for the phrase “What is the weather in New York City?” and the audio subsystem 108 converts the utterance 106 into corresponding acoustic frames 110 for input to the ASR system 100. Thereafter, the ASR model 200 receives, as input, the acoustic frames 110 corresponding to the utterance 106, and generates/predicts, as output, a corresponding transcription 120 (e.g., recognition result/hypothesis) of the utterance 106. In the example shown, the user device 102 and/or the remote computing device 201 also executes a user interface generator 107 configured to present a representation of the transcription 120 of the utterance 106 to the user 104 of the user device 102. In some configurations, the transcription 120 output from the ASR system 100 is processed, e.g., by a natural language understanding (NLU) module executing on the user device 102 or the remote computing device 201, to execute a user command. Additionally or alternatively, a text-to-speech system (e.g., executing on any combination of the user device 102 or the remote computing device 201) may convert the transcription into synthesized speech for audible output by another device. For instance, the original utterance 106 may correspond to a message the user 104 is sending to a friend in which the transcription 120 is converted to synthesized speech for audible output to the friend to listen to the message conveyed in the original utterance 106.

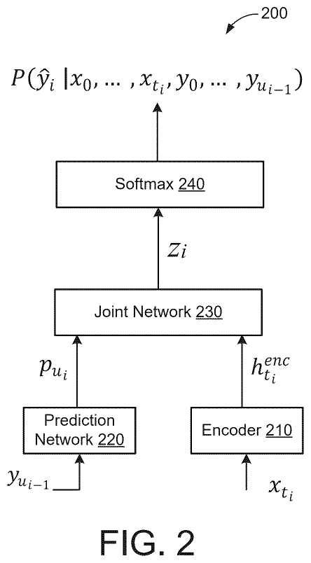

Referring to FIG. 2, the ASR model 200 may include a Recurrent Neural Network-Transducer (RNN-T) model architecture which adheres to latency constrains associated with interactive applications. The use of the RNN-T model architecture is exemplary, and the ASR model 200 may include other architectures such as transformer-transducer and conformer-transducer model architectures among others. The RNN-T model provides a small computational footprint and utilizes less memory requirements than conventional ASR architectures, making the RNN-T model architecture suitable for performing speech recognition entirely on the user device 102 (e.g., no communication with a remote server is required). The RNN-T model architecture of the ASR model 200 includes an encoder network 210, a prediction network 220, and a joint network 230. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, the encoder reads a sequence of d-dimensional feature vectors (e.g., acoustic frames 110 (FIG. 1) x=(x₁, x₂, . . . , x_{T}), where xₜ∈ [symbol] _{d}, and produces at each output step a higher-order feature representation. This higher-order feature representation is denoted as

$${h}_{1}^{enc} , … , {h}_{T}^{enc} .$$

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network then predicts P(y_i−|x(t_i), y_0, . . . , y_(u_(i−1))), which is a distribution over the next output symbol. Stated differently, the joint network 230 generates, at each output step (e.g., time step), a probability distribution over possible speech recognition hypotheses. As used herein, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the ASR model 200 at the corresponding output step. In this manner, the ASR model 200 does not make a conditional independence assumption, rather the prediction of each symbol is conditioned not only on the acoustics but also on the sequence of labels output so far. The ASR model 200 does assume an output symbol is independent of future acoustic frames 110, which allows the ASR model 200 to be employed in a streaming fashion, a non-streaming fashion, or some combination thereof.

In some examples, the encoder network (i.e., audio encoder) 210 of the RNN-T model 200 includes a stack of self-attention layers/blocks, such as conformer blocks, each including a multi-headed self-attention mechanism. Here, each conformer block includes a series of multi-headed self attention, depth wise convolution and feed-forward layers. The prediction network 220 may have two 2,048-dimensional LSTM layers, each of which is also followed by 640-dimensional projection layer. Alternatively, the prediction network 220 may include a stack of transformer or conformer blocks, or an embedding look-up table in lieu of LSTM layers. Finally, the joint network 230 may also have 640 hidden units. The Softmax layer 240 may be composed of a unified word piece or grapheme set that is generated using all unique word pieces or graphemes in a plurality of training data sets.

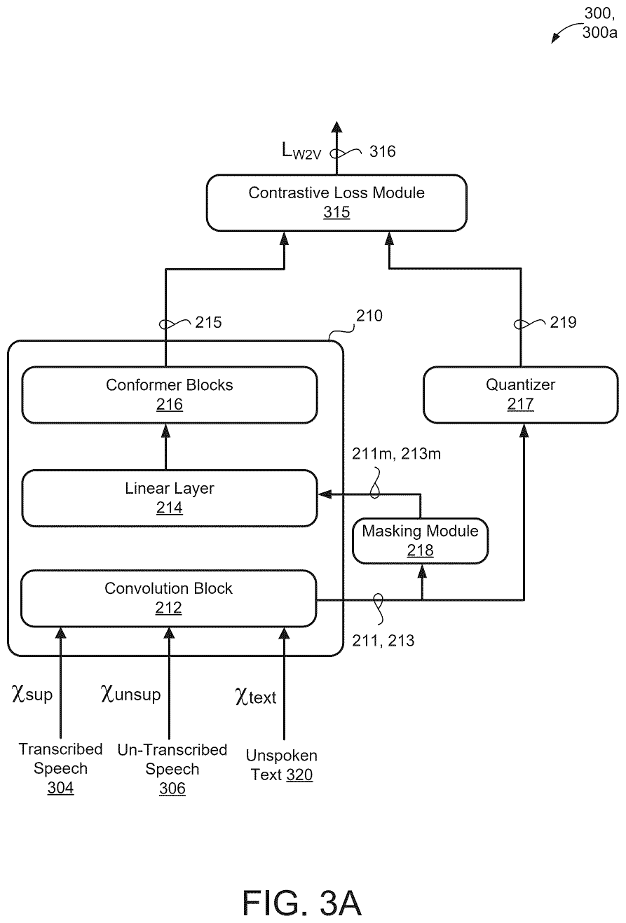

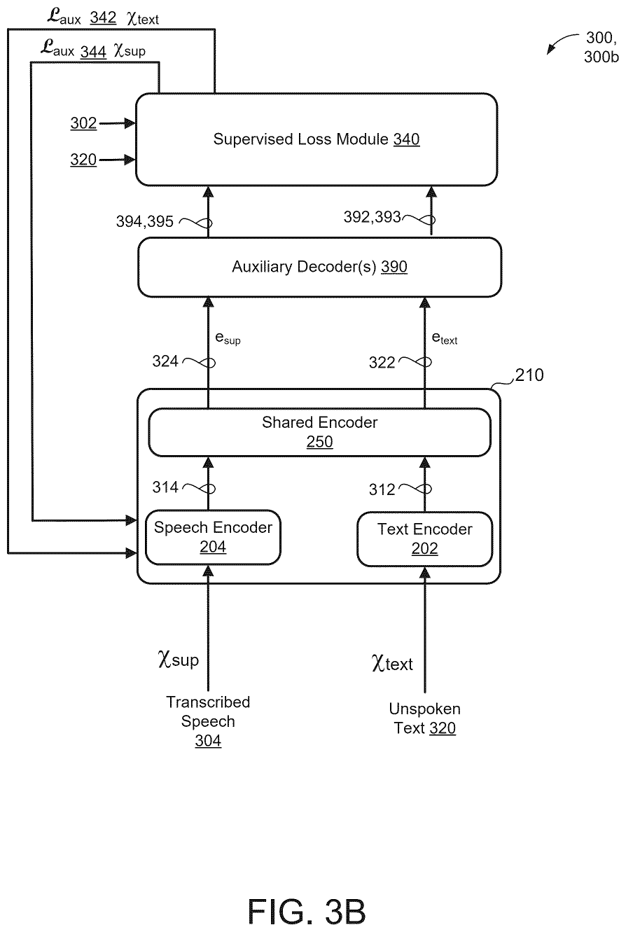

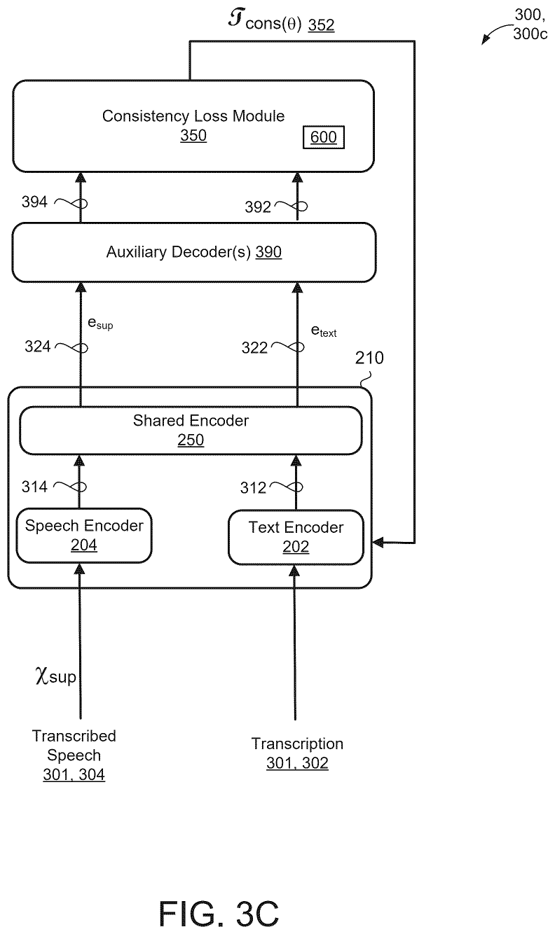

FIGS. 3A-3C illustrate an example training process 300 for pre-training the audio encoder 210 of the ASR model 200 (FIG. 2). The training process 300 may pre-train the audio encoder 210 using available training data that includes a set of unspoken textual utterances (Xₜₑₓₜ) 320, a set of transcribed non-synthetic speech utterances (Xₛᵤₚ) 304, and/or un-transcribed non-synthetic speech utterances (Xᵤₙₛᵤₚ) 306. Pre-training the audio encoder 210 may include updating parameters of any component of the audio encoder 210 based on any combination of derived losses. Each unspoken textual utterance 320 includes text-only data (i.e., unpaired data) such that each unspoken textual utterance 320 is not paired with any corresponding spoken audio representation (i.e., speech) of the utterance. The unspoken textual utterance 320 may include any sequence text chunks including words, word-pieces, phonemes, and/or graphemes. Each un-transcribed non-synthetic speech utterance 306 (also referred to as simply “un-transcribed speech utterance 306”) includes audio-only data (i.e., unpaired data) such that the un-transcribed speech utterance 306 is not paired with any corresponding transcription. On the other hand, each transcribed non-synthetic speech utterance 304 (also referred to as simply “transcribed speech utterance 304”) includes a corresponding transcription 302 paired with a corresponding non-synthetic speech representation of the corresponding transcribed speech utterance 304.

For simplicity, the training process 300 includes a contrastive self-supervised loss part 300a (FIG. 3A), a supervised loss part 300b (FIG. 3B), and a consistency regularization part 300c (FIG. 3C). The training process 300 pre-trains the audio encoder 210 on a total loss (Lₜₜₛ₄ₚᵣₑₜᵣₐᵢₙ₂) based on: contrastive losses (L_{w2v}) 316 derived using the contrastive self-supervised loss part 300a from the unspoken training text utterances (Xₜₑₓₜ) 320, a corpus of transcribed non-synthetic speech utterances (Xₛᵤₚ) 304, and un-transcribed non-synthetic speech utterances (Xᵤₙₛᵤₚ) 306; supervised losses (Lₐᵤₓ) 342, 344 derived using the supervised loss part 300b from the unspoken training text utterances (Xₜₑₓₜ) 320 and the transcribed non-synthetic speech utterances (Xₛᵤₚ) 304; and consistency losses ( [symbol] _{cons}(θ)) 352 derived using the consistency regularization part 300c. Notably, the training process 300 trains the audio encoder 210 on textual training data (e.g., transcriptions 302 and unspoken textual utterances) without employing a duration model or alignment model. That is, as will become apparent, the audio encoder 210 receives and processes the textual training data directly without applying any upsampling or duration modeling on the textual training data.

Referring to FIG. 3A, the contrastive self-supervised loss part 300a of the training process 300 pre-trains the audio encoder 210 on the transcribed non-synthetic speech utterances 304, the un-transcribed non-synthetic speech utterance 306, and the unspoken textual utterances 320. In some implementations, the audio encoder 210 includes a text encoder 202 and a speech encoder 204, described in more detail with reference to FIGS. 3B and 3C. In the example shown, the audio encoder 210 (alternatively the speech encoder 204 or the text encoder 202 (FIGS. 3B and 3C)) includes a Conformer encoder including a stack of conformer blocks each of which includes a series of multi-headed self attention, depth wise convolution, and feed-forward layers. Alternatively, the audio encoder 210 may include another type of encoder having a stack of self-attention layers/blocks, such as a transformer encoder. The Conformer encoder 210 can naturally be split into a feature encoder, including a convolution subsampling block 212, and a context network, including a linear layer 214 and a stack of Conformer blocks 216. In some implementations, the convolution subsampling block 212 has two two-dimensional-convolution layers, both with strides (2, 2), resulting in a 4× reduction in the feature sequence length. The convolution subsampling block 212 receives, as input, a sequence of input features/vectors (e.g., mel-frequency spectrograms such as the acoustic frames 110 of FIG. 1) associated with each transcribed non-synthetic speech utterance 304 and each un-transcribed non-synthetic speech utterance 306, and generates, as output, for each of a plurality of output steps, an encoded audio feature 211 that corresponds to a respective one of the transcribed non-synthetic speech utterances 304 or a respective one of the un-transcribed non-synthetic speech utterances 306. The convolution subsampling block 212 may receive, as input, each unspoken textual utterance 320 and generate, as output, for each of the plurality of output steps, an encoded textual feature 213 that corresponds to a respective one of the unspoken textual utterances 320.

The encoded audio and textual features 211, 213 (i.e., interchangeably referred to as “encoded features 211, 213”) output from the convolution subsampling block 212 may be fed to a masking module 218 where some of the encoded features 211, 213 are randomly chosen and replaced with a trained feature vector shared between all masked time steps to provide corresponding masked encoded audio features 211, 211m and masked encoded textual features 213, 213m. In some examples, the masking module 218 masks the randomly chosen encoded features 211, 213 for masking by randomly sampling without replacement a certain proportion p of all time steps to be start indices and then masks the subsequent M consecutive time steps from every sample index, whereby some spans may overlap. After masking is applied, the linear layer 214 and the Conformer blocks 216 of the context network receives the masked encoded features 211m (or encoded features 211, 213 not chosen by the masking module 218) and outputs corresponding contrastive context vectors (i.e., encoded representation) 215 from masked encoded features 211m, 213m. Moreover, a quantizer 217 receives the encoded features 211, 213 as input, and generates quantized vectors (i.e., target context vectors) 219 as output. Thereafter, a contrastive loss module 315 derives a contrastive loss (L_{w2v}) 316 between the contrastive context vectors 215 at the masked positions and the target context vectors 219 as follows.

$${ℒ}_{w 2 v} = - \frac{log exp ( \frac{sim ( {c}_{t} , {q}_{t} )}{k} )}{{\sum }_{\tilde{q} - {Q}_{t}} exp ( \frac{sim ( {c}_{t} , \tilde{q} )}{k} )} \qquad ( 1 )$$

where cₜ is contrastive context vector 215 centered over a masked time step t and qₜ represents a target context vector 219 at the time step t in a set of K+1 candidate target context vectors 219 which includes qₜ and K distractors. Distractors may be uniformly sampled from other masked time steps of the same utterance.

The contrastive loss 316 is optimized between the contrastive context vectors 215 at the masked positions and the target context vectors 219. After the audio encoder 210 converges on the un-transcribed non-synthetic speech utterances 306, the pre-training procedure is repeated on both the unspoken textual utterances 320 and the transcribed non-synthetic speech utterances 304. Thus, the contrastive loss (L_{w2v}) 316 is optimized for both real/human (non-synthetic) and the unspoken textual utterances 320, with additional auxiliary losses on the transcribed non-synthetic speech utterances 304 and the unspoken textual utterances 320 as described in greater detail below with reference to FIG. 3B. Accordingly, the training process 300a pre-trains the audio encoder 210 on the derived contrastive loss 316 applied on the corresponding encoded features 211, 213 associated with each unspoken textual utterance 320, each transcribed non-synthetic speech utterance 304, and each un-transcribed non-synthetic speech utterance 306 provided as input to the audio encoder 210. Pre-training the audio encoder 210 may include updating parameters of the audio encoder 210 based on the contrastive losses 316.

In some implementations, the quantizer 217 summarizes all of the encoded features 211, 213 into representative target quantized vector tokens (i.e., discriminative speech tokens). The representative target quantized vector tokens generated by the quantizer 217 represent a finite set of representative target quantized vector tokens referred to as a codebook. Moreover a target token index may map each corresponding encoded feature 211, 213 to a respective one of the target quantized vector tokens stored in the codebook. The quantizer may project the target context vector 221 to a randomly initialized codebook that maps the target context vectors 22 to discrete labels 229 by finding a nearest vector in the codebook. Here, the target context vector collectively refers to the target quantized vector tokens and the target token index. Notably, the quantizer 217 includes a random-projection quantizer 217 that is configured to randomly initialize a matrix and the codebook. The random-projection quantizer uses the matrix to project the encoded features 211, 213 into the target context vectors and uses the codebook to find a nearest vector where an index of the vector includes a label. As such, the contrastive loss may represent a Bidirectional Encoder Representations from Transformers (BERT)-based speech Pre-Training with Random Projection Quantizer (BEST-RQ) loss which does not require an additional quantization module that other contrastive losses (e.g., w2v-BERT) require. As such, since the BEST-RQ loss does not require the additional quantization module, the BEST-RQ loss enables the ASR model 200 to be more scalable during pre-training.

Referring to FIG. 3B, the supervised loss part 300b of the training process 300 is configured to inject lexical information into the audio encoder 210 during pre-training based on supervised loss terms 342, 344 derived from the transcribed non-synthetic speech utterances 304 and the unspoken textual utterances 320. Notably, the supervised loss part 300b leverages one or more auxiliary decoders 390 for generating the supervised loss terms 342, 344. The auxiliary decoders 390 may include Connectionist Temporal Classification (CTC) decoders, Listen Attend Spell (LAS) decoders, or RNN-T decoders. These auxiliary decoders 390 may include at least one of a phoneme decoder configured to decode a sequence of phonemes or a wordpiece decoder configured to decode a sequence of word pieces. The auxiliary decoders 390 could also include a grapheme decoder configured to decode a sequence of graphemes.

During the supervised loss part 300b, the text encoder 202 of the audio encoder 210 is configured to receive the unspoken textual utterances 320 and the speech encoder 204 is configured to receive transcribed non-synthetic speech utterances 304. Thus, the text encoder 202 of the audio encoder 210 generates encoded textual representations 312 for the unspoken textual utterances 320 and the speech encoder 204 of the audio encoder 210 generates encoded audio representations 314 for speech inputs (i.e., transcribed non-synthetic speech utterances 304). Here, the encoded textual representations 312 and the encoded audio representations 314 may not both be compatible with the auxiliary decoders 390. Thus, the audio encoder 210 may also include a shared encoder 250 that receives the encoded textual representations 312, as input, and generates a first encoded shared representation 322 (eₜₑₓₜ) as output. Moreover, the shared encoder 250 receives the encoded audio representations 314, as input, and generates a second encoded shared representation (eₛᵤₚ) 324 as output. Accordingly, the shared encoder 250 generates the first and second encoded shared representations 322, 324 into a shared latent representation space compatible with the auxiliary decoder 390.

In particular, the shared encoder 250 receives, as input, each encoded textual representation 312 that corresponds to the unspoken textual utterance 320 and generates, as output, for each of a plurality of output steps, the first encoded shared representation (eₜₑₓₜ) 322 that corresponds to the unspoken textual utterance 320 at the corresponding time step. The auxiliary decoder 390, including the phoneme decoder or the wordpiece decoder, receives, as input, each first encoded shared representation 322 output from the shared encoder 250 and generates, as output, a first probability distribution 392 over possible speech recognition hypotheses for the corresponding unspoken textual utterance 210 at the corresponding output step. In some examples, the first probability distribution 392 over possible speech recognition hypotheses includes one of possible phoneme labels, possible word piece labels, or possible grapheme labels. Thereafter, a supervised loss module 340 may determine an output loss term 342 based on the first probability distribution 392 over possible speech recognition hypotheses and the corresponding unspoken textual utterance 320. Here, the corresponding unspoken textual utterance 320 serves as a ground-truth transcription. The supervised loss part 300b may pre-train the audio encoder 210 on the output loss term 342 by updating parameters of the audio encoder 210 using the output loss term 342.

Similarly, during the supervised loss part 300b, the shared encoder 250 receives, as input, each transcribed encoded audio representation 314 that corresponds to the non-synthetic speech utterance 304 and generates, as output, for each of a plurality of time steps, a second encoded shared representation (eₛᵤₚ) 324 that corresponds to the transcribed non-synthetic speech utterance 304 at the corresponding time step. The auxiliary decoder 390, including the phoneme decoder or the wordpiece decoder, receives, as input, each second encoded shared representation 324 output from the shared encoder 250 and generates, as output, a second probability distribution 394 over possible speech recognition hypotheses for the corresponding transcribed non-synthetic speech utterance 304 at the corresponding output step. In some examples, the second probability distribution 394 over possible speech recognition hypotheses includes the one of possible phoneme labels, the possible word piece labels, or the possible grapheme labels. Thereafter, the supervised loss module 340 may determine a non-synthetic speech loss term 344 based on the second probability distribution 394 over possible non-synthetic speech recognition hypotheses and the corresponding transcription 302 paired with the transcribed non-synthetic speech utterance 304. Here, the corresponding transcription 302 serves as a ground-truth transcription and may include a sequence of target phonemes, target word pieces, and/or target graphemes. The supervised loss part 300b may pre-train the audio encoder 210 on the non-synthetic speech loss term 344 by updating parameters of the audio encoder 210 using the non-synthetic speech loss term 344.

In some implementations, the supervised loss part 300b of the training process 300 uses another auxiliary decoder 390 to generate a third probability distribution 393 over possible speech recognition hypotheses based on the first encoded shared representation (eₜₑₓₜ) 322 for the unspoken textual utterance 320 at the corresponding output step, whereby the supervised loss module 340 may determine another output loss term 342 based on the third probability distribution 393 and the unspoken textual utterance 320 corresponding to the unspoken textual utterance 320. Here, the other auxiliary decoder 390 includes the other one of the phoneme decoder, word piece decoder, or the grapheme decoder and the third probability distribution 393 over possible speech recognition hypotheses includes the other one of the possible phoneme labels, the possible word piece labels, or the possible grapheme labels. In these implementations, the other auxiliary decoder 390 also generates a fourth probability distribution 395 over possible speech recognition hypotheses for the corresponding second encoded shared representation 324 at the corresponding output step, whereby the supervised loss module 340 may determine another non-synthetic speech loss term 344 based on the fourth probability distribution 395 and the corresponding transcription 302 that is paired with the transcribed non-synthetic speech representation 304. Here, the fourth probability distribution 395 over possible non-synthetic speech recognition hypotheses includes the other one of the possible phoneme labels, the possible word piece labels, or the possible grapheme labels. The supervised loss part 300b of the training process 300 may similarly pre-train the audio encoder 210 on the other output loss term 342 and the other non-synthetic speech loss term 344.

The un-transcribed non-synthetic speech utterances 306 and the unspoken textual utterances 320 each correspond to “unpaired” training data whereby the contrastive loss (L_{w2v}) 316 derived from the unspoken textual utterances (Xₜₑₓₜ) 320 may be combined with the supervised loss [symbol] ₐᵤₓ associated with the output loss term 342 to obtain an unspoken textual loss function, [symbol] ₜₑₓₜ, as follows.

$${𝒥}_{text} = {ℒ}_{w 2 v} ( x \vert {θ}_{e} ) + {ℒ}_{aux} ( y \vert x , {θ}_{e} , {θ}_{d} ) \qquad ( 2 )$$

Likewise, the contrastive loss (L_{w2v}) 316 derived from the un-transcribed non-synthetic speech utterances (Xᵤₙₛᵤₚ) 306 may be used to express an unsupervised speech loss function, [symbol] _{unsup_speech}, as follows.

$${𝒥}_{{unsup}_{speech}} = {𝒥}_{w 2 v} ( {x}^{*} \vert {θ}_{e} ) \qquad ( 3 )$$

During pre-training of the audio encoder 210, the unspoken textual utterances 320 and the un-transcribed non-synthetic utterances 306 may be separated or mixed within each batch. In order to force the audio encoder 210 to learn representations that are effective for both the unspoken textual utterances 320 and non-synthetic (human/real) speech, the loss mask σ is applied when combining the loss functions [symbol] ₜₑₓₜ and of Equations. 2 and 3 to obtain an unpaired data loss function, [symbol] _{unpaired}, as follows.

$${𝒥}_{unpaired} = σ {𝒥}_{text} + ( 1 - σ ) {𝒥}_{speech} \qquad ( 4 )$$

The transcribed non-synthetic speech utterances 304 corresponds to “paired” and “supervised” training data whereby the derived contrastive loss L_{w2v} and the derived supervised loss [symbol] ₐᵤₓ associated with the non-synthetic speech loss term 344 may be combined to obtain a paired data loss function, [symbol] _{paired}, as follows.

$${𝒥}_{paired} = {ℒ}_{w 2 v} ( x \vert {θ}_{e} ) + {ℒ}_{aux} ( y \vert x , {θ}_{e} , {θ}_{d} ) \qquad ( 5 )$$

Referring to FIG. 3C, the consistency regularization part (i.e., modality matching part) 300c of the training process 300 is configured to promote the audio encoder 210 to learn consistent predictions between non-synthetic speech (e.g., real/human speech) and the corresponding transcriptions 302 by generating a consistent loss term ( [symbol] _{cons}(θ)) 352 between training utterance pairs 301. Here, each training utterance pair 301 includes a transcribed non-synthetic speech utterance 304 and a corresponding transcription 302 each corresponding to the same utterance. Notably, the corresponding transcription 302 is treated as unspoken text during the consistency regularization part 300c. Thus, the consistent loss term 352 between the transcribed non-synthetic speech utterance 304 and the corresponding transcription 302 provides an unsupervised training aspect by encouraging the audio encoder 210 to behave consistently regardless of whether the training utterance belongs to non-synthetic speech (i.e., speech training data) or the transcription 302 and independent of supervised loss terms between the ground-truth transcription 302 and each of: non-synthetic speech recognition hypotheses output by the auxiliary decoder 390; and speech recognition hypothesis output by the auxiliary decoder 390.

During the consistency regularization part 300c, the text encoder 202 receives, as input, each transcription 302 and generates, as output, for each of a plurality of output steps, an encoded textual representation 312 that corresponds to the transcription 302 at the corresponding output step. The shared encoder 250 receives, as input, the encoded textual representation 312 and generates, as output, a first encoded shared representation 324. The auxiliary decoder 390 including the phoneme decoder or the wordpiece decoder receives, as input, each first encoded shared representation 324 output from the shared encoder 250 and generates, as output, a first probability distribution 392 over possible speech recognition hypotheses for the corresponding transcription 302 at the corresponding output step. In some examples, the first probability distribution 311 over possible speech recognition hypotheses includes one of possible phoneme labels or possible word piece labels. Notably, each possible speech recognition hypothesis of the first probability distribution 392 includes non-blank output tokens. That is, since the textual input does not include any blank or silent frames, the speech recognition hypothesis similarly include non-blank output tokens. The non-blank output tokens may include letters, characters, and/or symbols.

Similarly, the speech encoder 204 receives, as input, each transcribed non-synthetic speech utterance 304 as a sequence of features/vectors (e.g., mel-frequency spectrograms such as the acoustic frames 110 of FIG. 1) and generates, as output, for each of a plurality of output steps, a encoded audio representation 314 that corresponds to the transcribed non-synthetic speech utterance 304 at the corresponding output step. The shared encoder 250 receives, as input, the encoded audio representation 314 and generates, as output, a second encoded shared representation (eₛᵤₚ) 324. The auxiliary decoder 390, including the phoneme decoder or the wordpiece decoder receives, as input, each second encoded shared representation 324 output from the shared encoder 250 and generates, as output, a second probability distribution 394 over possible speech recognition hypotheses for the corresponding transcribed non-synthetic speech utterance 304 at the corresponding output step. In some examples, the second probability distribution 394 over possible non-synthetic speech recognition hypotheses includes the one of the possible phoneme labels or the possible word piece labels. Notably, each possible speech recognition hypothesis of the first probability distribution 392 may include at least one non-blank output token and at least one blank output token. That is, since the speech input may include blank or silent frames (e.g., representing pauses or silences during speech), the speech recognition hypotheses similarly include non-blank output tokens and blank-output tokens. Here, the blank-output tokens represent no prediction by the auxiliary decoder 390 at the corresponding output step.

With continued reference to FIG. 3C, the consistency regularization part 300c of the training process 300 further determines, at each of the plurality of output steps for each training utterance pair 301, the consistent loss term ( [symbol] _{cons}(θ)) 352 for the corresponding training utterance pair 301 based on the first probability distribution 392 over possible speech recognition hypotheses and the second probability distribution 394 over possible speech recognition hypotheses. For instance, the training process 300 may employ a consistency loss term module 350 configured to receive, at each output step, the corresponding first probability distribution 392 and the corresponding second probability distribution 394 output by the auxiliary decoder 390, and determine the consistency loss term 352 for the corresponding training utterance pair 301 at the output step.

In some examples, the consistency regularization part 300c of the training process 300 determines the consistent loss term 352 based on a Kullback-Leibler divergence (D_{KL}) between the first probability distribution 392 over possible speech recognition hypotheses and the second probability distribution 394 over possible speech recognition hypotheses. Here, the consistent loss term 352 determined for the training utterance pair 301 at each time step provides an “unsupervised” loss term that is independent of the accuracy of the auxiliary decoder 390 (e.g., independent of the supervised loss terms 342, 344 of FIG. 3B), and thus, may be employed to update parameters of the audio encoder 210 for promoting consistency between non-synthetic speech representations and transcriptions of the same utterances. In batch training, the consistent loss term 352 may correspond to an average loss term obtained for the batch. In other words, the consistent loss term 352 permits the audio encoder 210 to learn to behave the same, e.g., make consistent encoded representation predictions on both non-synthetic speech (e.g., real/human speech) and unspoken text of a same training utterance, regardless of whether the training utterance belongs to non-synthetic speech or unspoken text.

In some instances, a length mismatch exists between the first probability distribution 392 over possible speech recognition hypothesis and the second probability distribution over possible speech recognition hypothesis. That is, since the transcriptions 302 used to generate first probability distributions 392 do not include any blank or silent input frames, the speech recognition hypotheses of the first probability distribution 392 include non-blank output tokens and do not include blank output tokens. On the other hand, since the transcribed non-synthetic speech utterances 304 include blank or silent input frames (e.g., representing pauses or silent speech frames), each speech recognition hypothesis of the second probability distribution 394 includes at least one blank token and at least one non-blank token. As a result, the speech recognition hypotheses from the first probability distribution 392 has a length mismatch with the speech recognition hypotheses from the second probability distribution 394 (e.g., due to the speech recognition hypotheses from the second probability distribution 394 include blank and non-blank output tokens). For example, a speech recognition hypothesis from the first probability distribution 392 may include “CAT” which includes non-blank output tokens only while a corresponding speech recognition hypothesis from the second probability distribution 394 includes “C_A_T” which includes non-blank output tokens and blank output tokens (e.g., “_”). Accordingly, this length mismatch makes it difficult for the consistency loss module 350 to directly compare the first and second probability distributions 392, 394 when determining the consistency loss 352.

To that end, in some examples, the consistency loss module 350 discards blank output tokens for each possible speech recognition hypothesis from the second probability distribution 394 and determines the consistency loss 352 between the first probability distribution 392 over possible speech recognition hypotheses and the second probability distribution 394 over possible speech recognition hypotheses with the blank output tokens discarded. Put another way, the consistency loss module determines the consistency loss 352 based on the first probability distribution 392 over possible speech recognition hypotheses and the at least one non-blank output token of each possible speech recognition hypothesis of the second probability distribution 394. Thus, the consistency loss 352 is not based on the at least one blank output token of each possible speech recognition hypothesis of the second probability distribution 394 because the blank output tokens are discarded. In this manner, the consistency loss module 350 removes the length mismatch between the first probability distribution 392 and the second probability distribution 394, and thus, determines the consistency loss 352 without the length mismatch. In some implementations, the consistency loss module 350 determines an alignment lattice 600 for each training utterance pair 301 based on the first probability distribution 392 over possible speech recognition hypotheses and the second probability distribution 394 over possible speech recognition hypotheses.

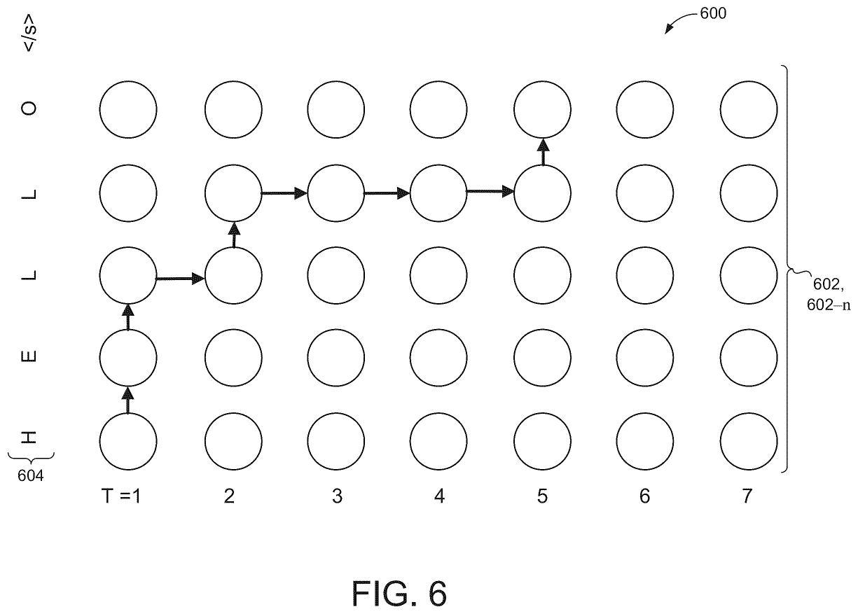

FIG. 6 shows an example alignment lattice 600 that includes a matrix of nodes 602, 602a-n. Each node 602 represents a vocabulary token (e.g., output token) from a plurality of vocabulary tokens. That is, the alignment lattice 600 includes U rows of nodes 602 whereby each row corresponds to a label token (e.g., non-blank output token) 604 that textually represents a portion of the sequence of acoustic frames 110. Moreover, the alignment lattice 600 includes T columns of nodes 602 whereby each column corresponds to an output step from the plurality of output steps. As described above, the auxiliary decoder 390 emits one of the label tokens (e.g., non-blank output tokens) or blanks output tokens at each output step. In the example shown, the label token 604 of each row of the alignment lattice 600 represents an alphabetic character for the word “HELLO.” Each alignment through the alignment matrix 600 represents a possible speech recognition hypothesis. An alignment is a sequence of through the alignment matrix 600. When the alignment moves in in a vertical direction through the alignment matrix 600 it represents the auxiliary decoder 390 outputting a non-blank output token. For example, at output step T=1, the auxiliary decoder 390 outputs non-blank output tokens of “H,” “E,” and “L.” On the other hand, when the alignment moves in a horizontal direction through the alignment matrix 600 it represents the auxiliary decoder 390 outputting a blank output token. For example, at output step T=2, the auxiliary decoder outputs a blank output token. Each possible path through the alignment matrix 600 represents a possible speech recognition hypothesis.

Referring again to FIG. 3C, in some implementations, the consistency loss module 350 determines the consistency loss 352 according to:

$${L}_{c} ( a ) = {\sum }_{( k , u ) ∈ a} {L}_{c} ( {e}_{s} ( k , u ) , {e}_{t} ( u ) ) \qquad ( 6 )$$

In Equation 6, L_{c} represents a pointwise consistency loss, eₛ(k, u) is the encoded audio representation 314 at frame k corresponding to an emission of a non-blank output symbol u, and eₜ(u) is the encoded textual representation 312 corresponding to the u-th symbol in the text sequence. The consistency loss module 350 only determines the consistency loss 352 for non-blank emissions represented by:

$${L}_{c} ( {e}_{s} ( . , ℰ ) , {e}_{t} ( . ) ) = 0 \qquad ( 7 )$$

Thus, summing up the pointwise consistency loss over all alignments from the alignment lattice 600 may be represented by:

$${L}_{c} = \frac{1}{p ( \frac{Y}{X} )} {\sum }_{a ∈ B ( Y )} p ( a ) * {L}_{c} ( a ) \qquad ( 8 )$$

$${L}_{c} = \frac{1}{p ( \frac{Y}{X} )} {E}_{a ∈ B ( Y )} [ {L}_{c} ( a ) ] \qquad ( 9 )$$

Here, X represents the speech sequence, Y represents the text sequence,

$$p ( \frac{Y}{X} )$$

represents the full probability assigned to Y given X, B(Y) is the set of all possible alignments, and p(a) is the probability assigned to a particular alignment. Thus, L_{c} can be efficiently computed using an expectation semi-ring according to:

$$:= \frac{1}{p ( \frac{Y}{X} )} log ( {E}_{a ∈ B ( Y )} [ {e}^{{L}_{c} ( a )} ] ) \qquad ( 10 )$$

Thus, normalizing the

$$\frac{1}{p ( \frac{Y}{X} )}$$

term represents the full likelihood of the sequence represented by:

$${E}_{a ∈ B ( Y )} [ {e}^{{L}_{c} ( a )} ] = {\sum }_{a ∈ B ( Y )} {\prod }_{( k , u ) ∈ a} p ( k , u ) * {e}^{{L}_{c} ( {e}_{s} ( k , u ) , {e}_{t} ( u ) )} \qquad ( 11 )$$

Therefore, minimizing [symbol] is equivalent to minimizing an upper bound on L_{c} represented by:

$${E}_{a ∈ B ( {Y}^{*} )} [ {e}^{{L}_{c} ( a )} ] \geq {e}^{{E}_{a ∈ B ( Y )} [ {L}_{c} ( a ) ]} \qquad ( 12 )$$

$$log ( {E}_{a ∈ B ( {Y}^{*} )} [ {e}^{{L}_{c} ( a )} ] ) \geq {E}_{a ∈ B ( Y )} [ {L}_{c} ( a ) ] \qquad ( 13 )$$

In some implementations, the consistency loss module 350 determines the consistency loss term 352 as a weighted RNN-T loss where the non-blank output tokens of the second probability distribution 394 are weighted by the corresponding pointwise consistency loss term. That is, the consistency loss includes the weighted RNN-T loss of the at least one non-blank output token of each possible speech recognition hypothesis of the second probability distribution 394.

Lastly, the training process 300 may combine the unpaired data loss function ( [symbol] _{unpaired}), the paired data loss function ( [symbol] _{paired}), and the consistent loss term ( [symbol] _{cons}) to obtain an overall loss term, [symbol] ₜₜₛ₄ₚᵣₑₜᵣₐᵢₙ₂, that may be expressed as follows.

$${𝒥}_{tts 4 pretrain 2} = {𝒥}_{unpaired} + {λ}_{1} 𝒥 paired + {λ}_{2} {𝒥}_{cons} \qquad ( 14 )$$

where λ₁ may be equal to 1.0 and λ₂ is equal to 0.1. The training process 300 may pre-train the audio encoder 210 using the overall loss term, [symbol] ₜₜₛ₄ₚᵣₑₜᵣₐᵢₙ₂, by updating parameters of the audio encoder 210 to effectively teach the audio encoder 210 to learn shared representations between speech and text. After pre-training the audio encoder 210, the training process 300 may fine-tune the pre-trained audio encoder on transcribed speech utterances that may include supervised training samples of both unspoken textual utterance 320 and non-synthetic (e.g., human speech).

In some implementations, the training process 300 for pre-training the audio encoder 210 applies encoder consistency regularization. Unlike decoder consistency regularization applied to auxiliary decoder(s) during the consistency regularization part 300c that requires hypothesized labels (e.g., transcripts 302 and unspoken textual utterances 320), encoder consistency regularization does not require hypothesized labels and therefore has the advantage being allowed to be applied to all the training data 304, 306, 320. Encoder consistency regularization may be applied via Hierarchical Contrastive consistency Regularization (HCCR) techniques where encoder activations e, e* from original/non-augmented and augmented speech are projected through an auxiliary network to generate z and z*. Thereafter, positive and negative pairs are constructive and a contrastive loss l_{t,z,z}* is calculated as follows.

$${l}_{t , z , {z}^{*}} = - log \frac{exp ( \frac{sim ( {z}_{t}^{*} , {z}_{t} )}{τ} )}{{\sum }_{k = 1}^{T} exp ( \frac{sim ( {z}_{t}^{*} , {z}_{k} )}{τ} )} \qquad ( 15 )$$

Specific to HCCR, a Convolutional Neural Network (CNN) projection network may calculate projections over increasing length segments of encoder activations e(30, 50, 120 ms) to yield 3 views (V) and draw negative examples from the same utterance for short segments, and from other utterances in the batches with 120 ms segments. Accordingly, an HCCR loss may be calculated over the transcribed non-synthetic speech utterances 304 (paired speech), the un-transcribed non-synthetic speech utterances 306 (unpaired speech), and the unspoken textual utterances 320 as follows.

$${ℒ}_{{enc}_{cons}} = {\sum }_{v = 1}^{V} {\sum }_{t = 1}^{{T}^{( v )}} {l}_{t , {z}^{* ( v )} , {z}^{( v )}} \qquad ( 16 )$$

The HCCR loss calculated by Equation 16 may be added to Equation 14 with a coefficient of 1e-3 as part of the overall loss term, [symbol] ₜₜₛ₄ₚᵣₑₜᵣₐᵢₙ₂, for use in pre-training the audio encoder 210.

Implementations described above describe the training process 300 training the pre-training the audio encoder 210, however, it is understood that the training process 300 may also be employed to train/pre-train a monolingual ASR model 200 or a multilingual ASR model 200. In some instances, the training process 300 may be employed to train end-to-end ASR models with decoder structures (i.e., non-pre-training) or fine-tune an ASR model to perform downstream tasks such as speech translation or natural language understanding. Moreover, the training process 300 may be used with training data source including unspoken textual utterances 320, transcribed non-synthetic speech utterances 304, and untranscribed non-synthetic speech utterances 306 independently, or using some combination thereof.

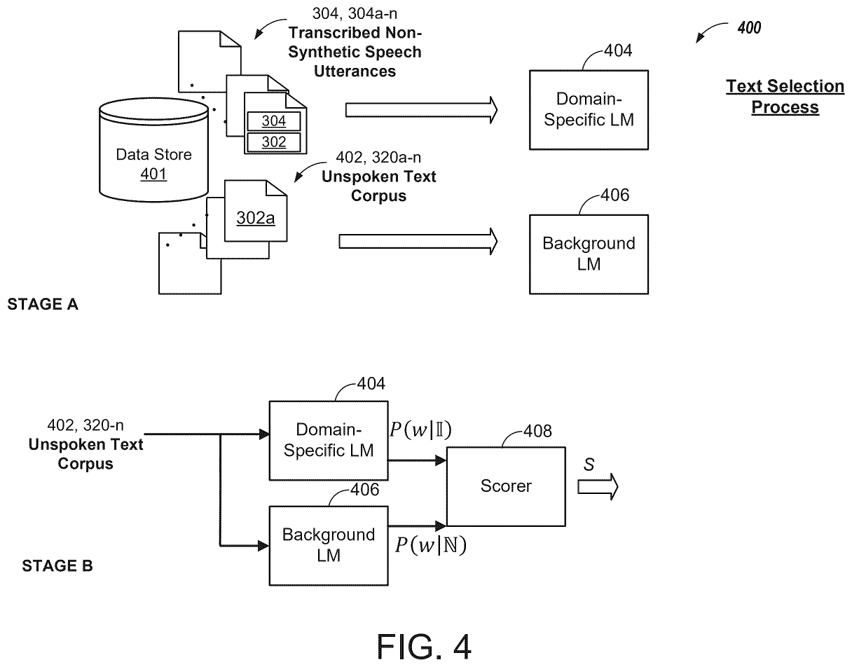

Referring to FIG. 4, a contrastive unspoken text selection process 400 may select the unspoken textual utterances 320 used for pre-training the audio encoder 210 from a large unspoken text corpus 402, whereby the selected unspoken textual utterances 320 are most similar to a specific domain the audio encoder 210 is being pre-trained to learn. That is, the text selection process 400 is able to identify in- and near-domain unspoken text from the unspoken text corpus 402 for inclusion in the unspoken textual utterances 320 for use in pre-training the audio encoder 210. Notably, unspoken textual utterances 320 selected by the selection process 400 enables the synthesizing of distinct utterances on-the-fly during batch construction such that a new speaker embedding z and latent variable Z may be sampled each time an unspoken textual utterance 320 is in a batch.

The corpus of unspoken text 402 includes a multitude of unspoken textual utterances 320, 320a-n from across a large range of domains, and includes a far greater linguistic diversity than the specific domain in which the audio encoder 210 is being trained to learn. As mentioned previously, the set of transcribed non-synthetic speech utterances 304 may be domain-specific in that they pertain to the specific domain and each non-synthetic speech utterance 304 is paired with a corresponding transcription 302. The corpus of unspoken text 402 may be stored in the same or different data store 401 as the spoken training utterances 304. The corpus of unspoken text 402 may dynamically change to incorporate new unspoken textual utterances 320. Simply using all unspoken textual utterances 320 in the unspoken text corpus 402 is not feasible for the following reasons: i) for each sentence, the speech modality needs much more memory to be encoded than text, thereby making converting all text in the corpus 402 impractical; and ii) the vast amount of difference between the transcriptions 302 paired with the transcribed non-synthetic speech utterances 304 and the unspoken textual utterances 320 in the unspoken text corpus 402 requires intelligent strategies to balance their contributions.

The text selection process 400 aims to select a subset of the available unspoken textual utterances 320 from the unspoken text corpus 402 as the data for TTS synthesis resulting in the unspoken textual utterances 320 generated for pre-training the audio encoder 210 during the contrastive loss and supervised loss parts 300a, 300b of the training process 300 described above with reference to FIGS. 3A and 3B. Stated differently, the text selection process 400 aims to improve the match between the selected subset of the available unspoken textual utterances 320 and the specific domain being targeted, which in turn reduces the computational resources required to exploit a large amount of non-domain-specific data. Accordingly, the text selection process 400 reduces computational and memory costs by selecting unspoken textual utterances 320 that best match the specific domain the audio encoder 210 is being trained to learn.

In some examples, the text selection process 400 selects the subset of the available unspoken textual utterances 320 from the corpus 402 that best match the specific domain by simply providing a domain identifier (not shown) associated with the specific domain as an input to the background LM 406 previously trained on the entire unspoken text corpus 402. As mentioned previously, the unspoken text corpus 402 spans a multitude of different domains. In these examples, the background LM 406 may include a maximum entropy (MaxEnt LM) capable of optionally accepting the domain identifier as input as described in U.S. Pat. No. 9,842,592, filed on Feb. 12, 2014, the contents of which is incorporated herein by reference in its entirety. Here, the domain identifier associated with the specific domain may allow the MaxEnt LM to output a subset of the available unspoken textual utterances 320 from the corpus 402 that are likely to include words and/or phrases pertaining to the specific domain. In some configurations, rather than evaluating likelihood of words, a statistical language model operates in reverse mode to randomly generate a text phrase that matches a statistical distribution of words pertaining to the specific domain.

In additional examples, and as depicted in FIG. 4, the text selection process 400 uses the transcriptions 302 paired with the transcribed non-synthetic speech utterances 304 spoken by human speakers to select the subset of the available unspoken textual utterances 320 from the corpus 402 that best match the specific domain. Here, the transcribed non-synthetic speech utterances 304 include words, phrases, and/or other terminology pertaining to the specific domain. Optionally, in addition to, or in lieu of the transcriptions 304 paired with the transcribed non-synthetic speech utterances 304, a set of different transcribed utterances that pertain to the specific domain can be used for selecting the unspoken textual utterances 320. This would provide the advantage of not requiring all the transcribed non-synthetic speech utterances 304 to belong to the specific domain.

During a first stage (STAGE A), the unspoken text selection process 400 builds the two language models 404, 406 to enable contrastive selection of the unspoken textual utterances 320. Here, the domain-specific LM 410 is trained on each transcription 302 in the set of transcribed non-synthetic speech utterances 304. The set of transcribed non-synthetic speech utterances 304 is assumed to belong to the specific-domain for which the audio encoder 210 is being trained to learn. On the other hand, the background LM 406 is trained on each unspoken textual utterance 320 in the entire unspoken text corpus 402. As mentioned previously, the unspoken text corpus 402 spans a multitude of different domains. In some examples, the first stage uses n-gram language model training to build the two language models 404, 406. In other examples, the first stage uses neural network language model training to build the two language models 404, 406.

During a second state (STAGE B), the unspoken text selection process 400 uses the two contrastive LMs 404, 406 to evaluate each unspoken textual utterance 320 in the unspoken text corpus 402 by determining a first probability, P(w|II), associated with each word in the unspoken textual utterance 320 appearing in the domain-specific LM 404 and determining a second probability, P(w|N), associated with each word in the unspoken textual utterance 320 appearing in in the background LM 406. Thereafter, for each unspoken textual utterance 320 in the unspoken text corpus 402, the process 400 determines, at a scorer 408, a score, S, based on the first probability, the second probability, and a number of words, #(w), appearing in the corresponding unspoken textual utterance 320. For example, the score S for each unspoken textual utterance 320 may be calculated as follows.

$$S = \frac{log P ( w \vert 𝕀 ) - log P ( w \vert ℕ )}{\# ( w )} \qquad ( 17 )$$

After determining the scores, the unspoken text selection process 400 selects the unspoken textual utterances 320 with the N-best scores S as these unspoken textual utterances 320 best match the specific domain. The text corpus 402 may include billions of unspoken textual utterances 320. The unspoken textual utterances 320 selected by the selection process 400 can include millions of utterances, and thus, far exceed the number of un-transcribed non-synthetic speech utterances 304 spoken by human speakers. As discussed above, the content of the unspoken textual utterances 320 increases linguistic diversity for the specific domain the audio encoder 210 is being trained to learn, while the unspoken textual utterances 320 increases acoustic/lexical diversity for the speech that the audio encoder 210 is encoding as part of the speech recognition process when the audio encoder 210 is integrated within the ASR model 200.

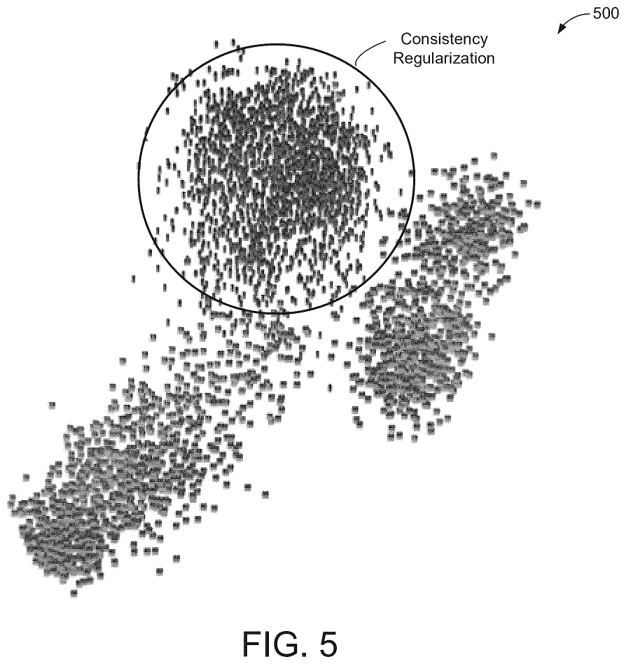

FIG. 5 illustrates an example projected space 500 of encoder representations of unspoken textual utterances 320 and non-synthetic (real/human) speech utterances. After introducing consistency regularization via the consistency regularization part 300c of FIG. 3C for pre-training the audio encoder, the resulting speech and text encoder representations learned stay much closer to each other compared to the speech and text encoder representations when consistency regularization is not applied. Accordingly, the projected space 500 shows that the use of supervised training data (i.e., the transcribed non-synthetic speech utterances) for pre-training the audio encoder 210 effectively generates improved shared speech and text representations.

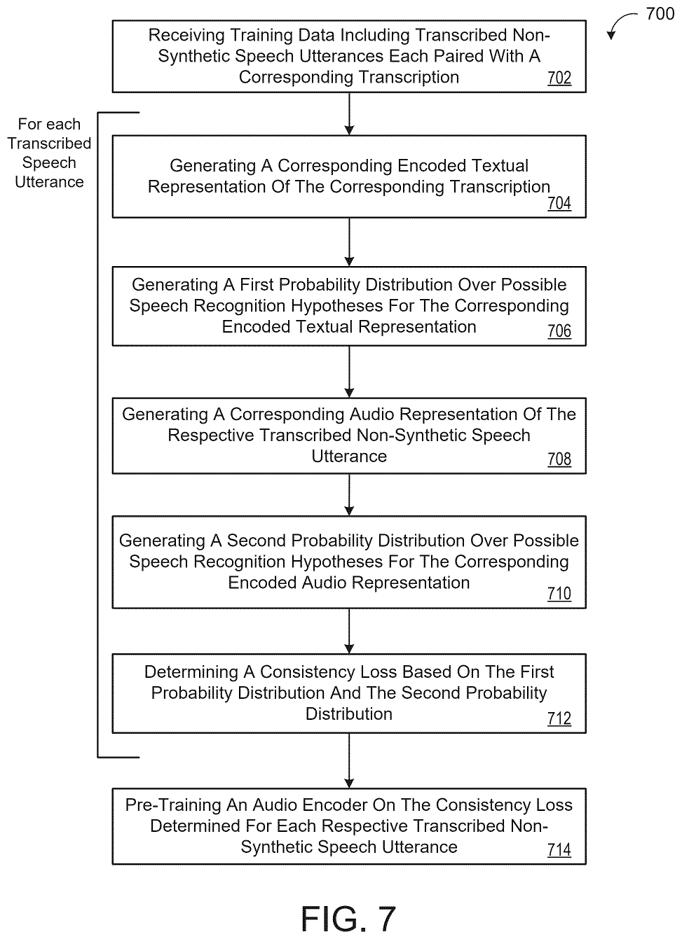

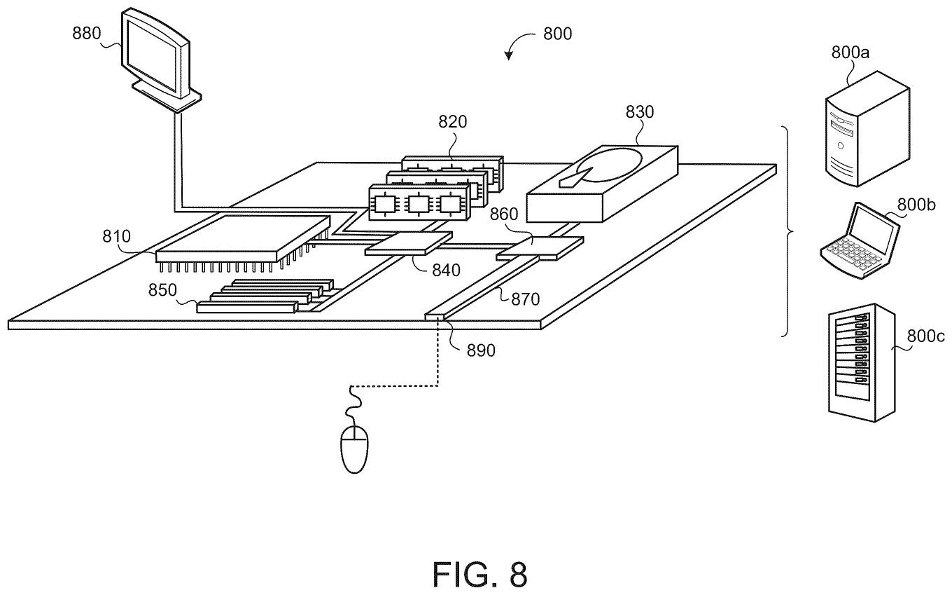

FIG. 7 is a flowchart of an example arrangement of operations for a computer-implemented method 700 of pre-training an audio encoder 210 to jointly learn shared representations of speech and text. The method 700 may execute on data processing hardware 810 (FIG. 8) using instructions stored on memory hardware 820 (FIG. 8). The data processing hardware 810 and the memory hardware 820 may reside on the user device 102 or the remote computing device 201 of FIG. 1 each corresponding to a computing device 800 (FIG. 8).

At operation 702, the method 700 includes receiving training data for pre-training an audio encoder 210. That training data includes transcribed non-synthetic speech utterances 304 each paired with a corresponding transcription 302. For each respective transcribed non-synthetic speech utterance 304, the method 700 performs operations 704-712. At operation 704, the method 700 includes generating a corresponding encoded textual representation 312 of the corresponding transcription 302 using a text encoder 202 of the audio encoder 210. At operation 706, the method 700 includes generating a first probability distribution 392 over possible speech recognition hypotheses for the corresponding encoded textual representation 312. At operation 708, the method 700 includes generating a corresponding encoded audio representation 314 of the respective transcribed non-synthetic speech utterance 304 using a speech encoder 204 of the audio encoder 210. At operation 710, the method 700 includes generating a second probability distribution 394 over possible speech recognition hypotheses for the corresponding encoded audio representation 314. Each possible speech recognition hypothesis of the second probability distribution 314 includes at least one blank output token and at least one non-blank output token. At operation 712, the method 700 includes determining a consistency loss 352 based on the first probability distribution 392 over possible speech recognition hypotheses and the at least one non-blank output token of each possible speech recognition hypothesis of the second probability distribution 394. At operation 714, the method 700 includes pre-training the audio encoder 210 on the consistency loss 352 determined for each respective transcribed non-synthetic speech utterance 304 to teach the audio encoder 210 to jointly learn shared speech and text representations.

FIG. 8 is a schematic view of an example computing device 800 that may be used to implement the systems and methods described in this document. The computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 800 includes a processor 810, memory 820, a storage device 830, a high-speed interface/controller 840 connecting to the memory 820 and high-speed expansion ports 850, and a low speed interface/controller 860 connecting to a low speed bus 870 and a storage device 830. Each of the components 810, 820, 830, 840, 850, and 860, are interconnected using various busses, and may be mounted on a common motherboard or in other manners as appropriate. The processor 810 can process instructions for execution within the computing device 800, including instructions stored in the memory 820 or on the storage device 830 to display graphical information for a graphical user interface (GUI) on an external input/output device, such as display 880 coupled to high speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 820 stores information non-transitorily within the computing device 800. The memory 820 may be a computer-readable medium, a volatile memory unit(s), or non-volatile memory unit(s). The non-transitory memory 820 may be physical devices used to store programs (e.g., sequences of instructions) or data (e.g., program state information) on a temporary or permanent basis for use by the computing device 800. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 830 is capable of providing mass storage for the computing device 800. In some implementations, the storage device 830 is a computer-readable medium. In various different implementations, the storage device 830 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 820, the storage device 830, or memory on processor 810.

The high speed controller 840 manages bandwidth-intensive operations for the computing device 800, while the low speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and a low-speed expansion port 890. The low-speed expansion port 890, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 800a or multiple times in a group of such servers 800a, as a laptop computer 800b, or as part of a rack server system 800c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving training data for pre-training an audio encoder, the training data comprising transcribed non-synthetic speech utterances, each respective transcribed non-synthetic speech utterance paired with a corresponding transcription;
for each respective transcribed non-synthetic speech utterance:
generating, using a text encoder of the audio encoder, a corresponding encoded textual representation of the corresponding transcription;
generating a first probability distribution over possible speech recognition hypotheses for the corresponding encoded textual representation;
generating, using a speech encoder of the audio encoder, a corresponding encoded audio representation of the respective transcribed non-synthetic speech utterance;
generating a second probability distribution over possible speech recognition hypotheses for the corresponding encoded audio representation, each possible speech recognition hypothesis of the second probability distribution comprising at least one blank output token and at least one non-blank output token; and
determining a consistency loss based on the first probability distribution over possible speech recognition hypotheses and the at least one non-blank output token of each possible speech recognition hypothesis of the second probability distribution; and
pre-training the audio encoder based on the consistency loss determined for each respective transcribed non-synthetic speech utterance to teach the audio encoder to jointly learn shared speech and text representations.

2. The computer-implemented method of claim 1, wherein the audio encoder comprises a stack of self-attention layers each including a multi-headed self-attention mechanism.

3. The computer-implemented method of claim 1, wherein:
the training data further comprises:
unspoken textual utterances, each unspoken textual utterance not paired with any corresponding spoken utterance of non-synthetic speech; and
un-transcribed non-synthetic speech utterances, each un-transcribed non-synthetic speech utterance not paired with a corresponding transcription; and
the audio encoder is further pre-trained on the unspoken textual utterances and the un-transcribed non-synthetic speech utterances to jointly learn the shared speech and text representations.

4. The computer-implemented method of claim 3, wherein pre-training the audio encoder comprises:
for each respective un-transcribed non-synthetic speech utterance:
generating a corresponding encoded representation of the un-transcribed non-synthetic speech utterance; and
pre-training the audio encoder on a contrastive loss applied on the corresponding encoded representation of the respective un-transcribed non-synthetic speech utterance;
for each respective unspoken textual utterance:
generating a corresponding encoded representation of the respective unspoken textual utterance; and
pre-training the audio encoder on a contrastive loss applied on the corresponding encoded representation of the respective unspoken textual utterance; and
for each respective transcribed non-synthetic speech utterance:
generating a corresponding encoded representation of the respective transcribed non-synthetic speech utterance; and
pre-training the audio encoder on a contrastive loss applied on the corresponding encoded representation of the respective transcribed non-synthetic speech utterance.

5. The computer-implemented method of claim 3, wherein pre-training the audio encoder comprises:
at each of a plurality of output steps for each respective unspoken textual utterance:
generating, using an auxiliary decoder, a third probability distribution over possible speech recognition hypotheses for the respective unspoken textual utterance;
determining an output loss term based on the third probability distribution over possible speech recognition hypotheses and the respective unspoken textual utterance; and
pre-training the audio encoder based on the output loss term; and
at each of a plurality of output steps for each transcribed non-synthetic speech utterance:
determining a non-synthetic speech loss term based on the second probability distribution over possible speech recognition hypotheses and the corresponding transcription paired with the respective transcribed non-synthetic speech utterance; and
pre-training the audio encoder based on the non-synthetic speech loss term.

6. The computer-implemented method of claim 5, wherein the auxiliary decoder comprises one of a Connection Temporal Classification (CTC) decoder, a Listen Attend Spell (LAS) decoder, or Recurrent Neural Network-Transducer (RNN-T) decoder.

7. The computer-implemented method of claim 1, wherein the audio encoder comprises a shared encoder.

8. The computer-implemented method of claim 7, wherein the operations further comprise:
for each respective unspoken textual utterance:
determining, using the text encoder, an encoded textual representation of the respective unspoken textual utterance; and
generating, using the shared encoder, a first encoded shared representation of the respective unspoken textual utterance in a shared latent representation space; and
for each respective transcribed non-synthetic speech utterance, generating, using the shared encoder, a second encoded shared representation of the transcribed non-synthetic speech utterance in a shared latent representation space.

9. The computer-implemented method of claim 1, wherein the consistency loss is not based on the at least one blank output token of each possible speech recognition hypothesis of the second probability distribution.

10. The computer-implemented method of claim 1, wherein the consistency loss comprises a weighted Recurrent Neural Network-Transducer (RNN-T) loss of the at least one non-blank output token of each possible speech recognition hypothesis of the second probability distribution.

11. A system comprising:
data processing hardware; and
memory hardware in communication with the data processing hardware, the memory hardware storing instructions that when executed on the data processing hardware cause the data processing hardware to perform operations comprising:
receiving training data for pre-training an audio encoder, the training data comprising transcribed non-synthetic speech utterances, each respective transcribed non-synthetic speech utterance paired with a corresponding transcription;
for each respective transcribed non-synthetic speech utterance:
generating, using a text encoder of the audio encoder, a corresponding encoded textual representation of the corresponding transcription;
generating a first probability distribution over possible speech recognition hypotheses for the corresponding encoded textual representation;
generating, using a speech encoder of the audio encoder, a corresponding encoded audio representation of the respective transcribed non-synthetic speech utterance;
generating a second probability distribution over possible speech recognition hypotheses for the corresponding encoded audio representation, each possible speech recognition hypothesis of the second probability distribution comprising at least one blank output token and at least one non-blank output token; and
determining a consistency loss based on the first probability distribution over possible speech recognition hypotheses and the at least one non-blank output token of each possible speech recognition hypothesis of the second probability distribution; and
pre-training the audio encoder on the consistency loss determined for each respective transcribed non-synthetic speech utterance to teach the audio encoder to jointly learn shared speech and text representations.

12. The system of claim 11, wherein the audio encoder comprises a stack of self-attention layers each including a multi-headed self-attention mechanism.

13. The system of claim 11, wherein:
the training data further comprises:
unspoken textual utterances, each unspoken textual utterance not paired with any corresponding spoken utterance of non-synthetic speech; and
un-transcribed non-synthetic speech utterances, each un-transcribed non-synthetic speech utterance not paired with a corresponding transcription; and
the audio encoder is further pre-trained on the unspoken textual utterances and the un-transcribed non-synthetic speech utterances to jointly learn the shared speech and text representations.

14. The system of claim 13, wherein pre-training the audio encoder comprises:
for each respective un-transcribed non-synthetic speech utterance:
generating a corresponding encoded representation of the un-transcribed non-synthetic speech utterance; and
pre-training the audio encoder on a contrastive loss applied on the corresponding encoded representation of the respective un-transcribed non-synthetic speech utterance;
for each respective unspoken textual utterance:
generating a corresponding encoded representation of the respective unspoken textual utterance; and
pre-training the audio encoder on a contrastive loss applied on the corresponding encoded representation of the respective unspoken textual utterance; and
for each respective transcribed non-synthetic speech utterance:
generating a corresponding encoded representation of the respective transcribed non-synthetic speech utterance; and
pre-training the audio encoder on a contrastive loss applied on the corresponding encoded representation of the respective transcribed non-synthetic speech utterance.

15. The system of claim 13, wherein pre-training the audio encoder comprises:
at each of a plurality of output steps for each respective unspoken textual utterance:
generating, using an auxiliary decoder, a third probability distribution over possible speech recognition hypotheses for the respective unspoken textual utterance;
determining an output loss term based on the third probability distribution over possible speech recognition hypotheses and the respective unspoken textual utterance; and
pre-training the audio encoder based on the output loss term, and
at each of a plurality of output steps for each transcribed non-synthetic speech utterance:
determining a non-synthetic speech loss term based on the second probability distribution over possible speech recognition hypotheses and the corresponding transcription paired with the respective transcribed non-synthetic speech utterance; and
pre-training the audio encoder based on the non-synthetic speech loss term.

16. The system of claim 15, wherein the auxiliary decoder comprises one of a Connection Temporal Classification (CTC) decoder, a Listen Attend Spell (LAS) decoder, or Recurrent Neural Network-Transducer (RNN-T) decoder.

17. The system of claim 11, wherein the audio encoder comprises a shared encoder.

18. The system of claim 17, wherein the operations further comprise:
for each respective unspoken textual utterance:
determining, using the text encoder, an encoded textual representation of the respective unspoken textual utterance; and
generating, using the shared encoder, a first encoded shared representation of the respective unspoken textual utterance in a shared latent representation space; and
for each respective transcribed non-synthetic speech utterance, generating, using the shared encoder, a second encoded shared representation of the transcribed non-synthetic speech utterance in a shared latent representation space.

19. The system of claim 11, wherein the consistency loss is not based on the at least one blank output token of each possible speech recognition hypothesis of the second probability distribution.

20. The system of claim 11, wherein the consistency loss comprises a weighted Recurrent Neural Network-Transducer (RNN-T) loss of the at least one non-blank output token of each possible speech recognition hypothesis of the second probability distribution.
